(19) United States
(12) Patent Application Publication
(10) Pub. No.: US 2021/0171804 A1
(43) Pub. Date: Jun. 10, 2021

(54) LOW COMBUSTIBILITY ADHESIVE COMPOSITION WITH LAYERED CONSTRUCTION

(71) Applicant: 3M INNOVATIVE PROPERTIES COMPANY, St. Paul, MN (US)

(72) Inventors: Eumi Pyun, Saint Paul, MN (US); Shinsuke Kondo, Yamagata (JP); Masaaki Furusawa, Yamagata (JP); Kazuyuki Hattori, Kanagawa (JP); Lynn E. Lorimor, Minneapolis, MN (US); Dong-Wei Zhu, North Oaks, MN (US)

(21) Appl. No.: 16/760,677

(22) PCT Filed: Oct. 31, 2018
(86) PCT No.: PCT/IB2018/058567

§ 371 Date: Apr. 30, 2020

Related U.S. Application Data
(60) Provisional application No. 62/580,140, filed on Nov. 1, 2017.

(51) Int. Cl. C09J 7/24; C09J 133/08; C08K 5/521; C09J 107/00; C09J 163/00; C09J 167/00; C09J 183/04

(52) U.S. Cl. CPC C09J 7/245; C09J 133/08; C08K 5/521; C08K 3/2279; C09J 163/00; C09J 167/00; C09J 183/04; C09J 107/00

(57) ABSTRACT

The present disclosure relates to a low-combustibility film construction. The film construction includes a film layer, a first adhesive layer with a fire-retardant additive of at least 41% by weight and a second adhesive layer. The total thickness of the adhesive layers is in the range of 18.5 to 44.5 microns. The total thickness of the fire retardant adhesive layer is 32% to 85% of the total adhesive thickness.

### FIELD OF INVENTION

The present disclosure relates to a film article having a layered adhesive construction, where at least one adhesive layer includes a fire-retardant additive.

### BACKGROUND

Many countries have low combustibility or low flammability requirements for film products applied to surfaces such as the interior or exterior of a building, such as a hotel, school, hospital or restaurant; or to a vehicle, such as a train, tractor trailer or personal vehicle or aircraft. Such requirements can help to increase safety for individuals in that area by decreasing likelihood of an explosion or fire spreading in the event of a spark or ignition.

At the same time, many customers also have adhesive tack and peel requirements when purchasing film to ensure that the film will weather well, remain adhered to the desired surface for the desired length of time, and can be removed when desired.

It can be challenging to create a product that meets both low combustibility and low flammability requirements and adhesion requirements simultaneously.

### SUMMARY

The present invention provides a way to decrease combustibility or flammability of a film construction while maintaining good adhesive tack and peel. The present disclosure provides a solution for constructing a film that is sufficiently thin so that it meets fire growth rate (FIGRA) requirements, and total heat release (THR) requirements instituted by different jurisdictions or customers. In some jurisdictions, FIGRA and THR can be very difficult to meet while maintaining acceptable adhesion properties. Even though the film is thin, the layered adhesive construction of the present disclosure allows for the film to also meet adhesion requirements.

In one instance, the present disclosure includes a low-combustibility film construction. The film construction includes a film layer; a first adhesive layer with a fire-retardant additive of at least 41% by weight; and a second adhesive layer. The total thickness of the adhesive layers is in the range of 18.5 to 44.5 microns; and wherein the total thickness of the fire retardant adhesive layer is 32% to 85% of the total adhesive thickness.

In another instance, the present disclosure includes a low-combustibility film construction. The film construction includes a film layer; a first adhesive layer with a fire-retardant additive of at least 41% by weight; and a second adhesive layer. The total thickness of the fire retardant adhesive layer is 32% to 85% of the total adhesive thickness, and the film has a peel adhesion greater than or equal to 20 N under the 180 Peel Adhesion Test.

In another instance, the present disclosure includes a low-combustibility film construction. The film construction includes a film layer; a first adhesive layer with a fire-retardant additive of at least 41% by weight; and a second adhesive layer. The total thickness of the adhesive layers is in the range of 18.5 to 44.5 microns; and the film has a total heat release less than or equal to 8 MJ/m² under the flammability test and wherein the film construction has a Fire Growth Rate (FIGRA) of less than or equal to 8 KW/(m²*s).

In some instances, the film layer comprises at least one of: polyvinylchloride (PVC), polyester, polyethylene terephthalate, low density polyethylene, ethylene methacrylate copolymer, polypropylene, polyimide, polyurethane, polyinylidene fluoride, polymethyl methacrylate, acrylic, silicone, and polyolefin films.

In some instances, the film is a graphic film and an ink layer is deposited on the film layer.

In some instances, the film layer has a thickness of 200 microns or less.

In some instances, the film layer has a thickness in the range of 125-145 microns.

In some instances, the first adhesive layer is adjacent to the film layer.

In some instances, the film construction further comprises a third adhesive layer, wherein the third adhesive layer does not have a fire retardant additive, and wherein the third adhesive layer is disposed between the film layer and the first adhesive layer.

In some instances, the first adhesive layer comprises at least one of: acrylic adhesive, natural rubber, synthetic rubber, silicone, polyester, polyolefin, rosin, and epoxy adhesive resins, not limited to these general pressure sensitive adhesive resins.

In some instances, the second adhesive layer comprises acrylic adhesive.

In some instances, the film construction has a peel adhesion greater than or equal to 20 N under the 180 Peel Adhesion Test.

In some instances, the film construction has a total heat release less than or equal to 8 MJ/m² under the flammability test.

In some instances, the film construction has a Fire Growth Rate (FIGRA) of less than or equal to 8 KW/(m²*s).

In some instances, the fire retardant additive comprises at least one of: tris(tribromoneopentyl) phosphate (TTBP), antimony trioxide (ATO) flame retardant, ammonium polyphosphate (APP) flame retardant, alumina trihydrate (ATH) flame retardant, and antimony trioxide (SbO₂) flame retardant.

In some instances, the film construction further comprises a third adhesive layer, wherein the third adhesive layer does not have a fire retardant additive, and wherein the third adhesive layer is disposed between the film layer and the first adhesive layer.

In some instances, the first adhesive layer comprises at least one of: acrylic adhesive, natural rubber, synthetic rubber, silicone, polyester, polyolefin, rosin, and epoxy adhesive resins, not limited to these general pressure sensitive adhesive resins.

In some instances the fire retardant additive comprises at least one of: tris(tribromoneopentyl) phosphate (TTBP), antimony trioxide (ATO) flame retardant, ammonium polyphosphate (APP) flame retardant, alumina trihydrate (ATH) flame retardant, and antimony trioxide (SbO₂) flame retardant.

### BRIEF DESCRIPTION OF THE DRAWINGS

The invention may be more completely understood when considered with the following detailed description in connection with the accompanying drawings, in which:

FIG. 1 shows a film construction with two layers of adhesive.

FIG. 2 shows a film construction with three layers of adhesive.

FIG. 3 shows a film construction with a liner.

The embodiments shown and described herein may be utilized and structural changes may be made without departing from the scope of the invention. The figures are not necessarily to scale. Like numbers used in the figures refer to like components. However, the use of a number to refer to a component in a given figure is not intended to limit the component in another figure labeled with the same number.

### DETAILED DESCRIPTION

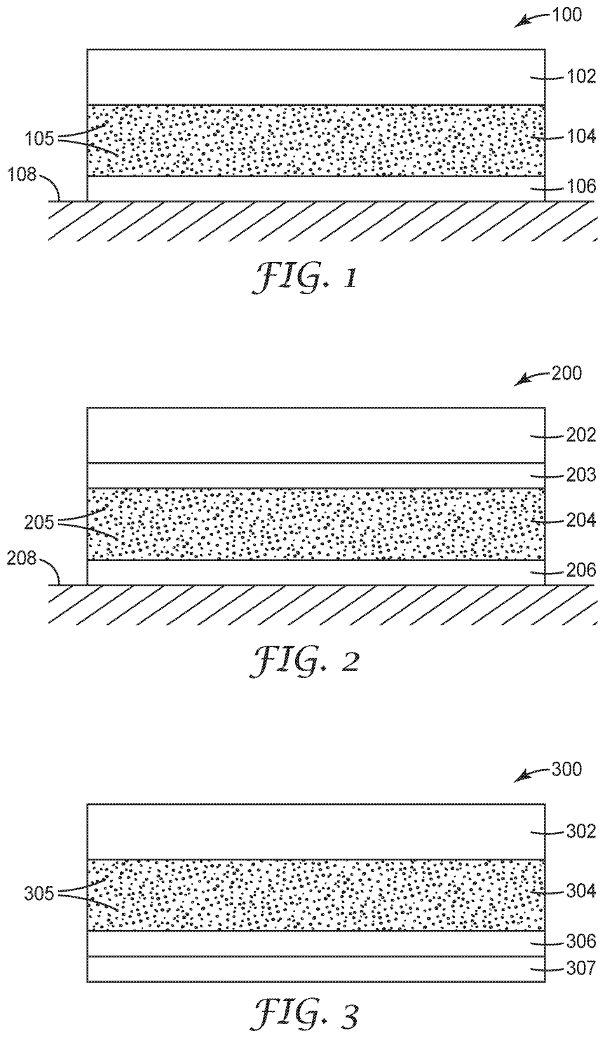

FIG. 1 shows a film construction 100 with two layers of adhesive 104, 106 applied to substrate 108. Film 102 may be any suitable film, such as a film comprising polyvinylchloride (PVC), polyester, polyethylene terephthalate, low density polyethylene, ethylene methacrylate copolymer, polypropylene, polyimide, polyurethane, polyinylidene fluoride, polymethyl methacrylate, acrylic, silicone, and polyolefin films or any combination thereof. Film 102 may be calendared or case and may be made of any of the materials discussed herein, including in the examples. The thickness of film 102 may vary. For example, it may range from, for example, about 20 um to 300 um. Film thickness 102 may be about 20 um, 30 um, 40 um, 50 um, 60 um, 70 um, 80 um, 90 um, 100 um, 125 um, 150 um, 175 um, 200 um, 225 um, 250 um 275 um and 300 um, or any range between any of the preceding values. The maximum thickness of a particular film will depend on a variety of factors, including the relative combustibility of the polymer in the film.

Film 102 may be a graphic film. It may have colors, patterns, textures or images printed on it with a variety of inks and methods. In some instances, film 102 may be transparent or translucent. Film 102 may have a range of opacities and a variety of colors. In some instances, film 102 may be a functional film which provides functions including abrasion resistance, easy cleaning or surface protection from damage.

Adhesive layer 104 is disposed between and adjacent to each of film layer 102 and adhesive layer 106. In some instances, a primer may be added between film layer 102 and adhesive layer 104 to increase adhesion between the two layers. Film layer 102 and adhesive layer 104 are considered adjacent when a primer layer is used to bond film layer 102 and adhesive layer 104. Adhesive layer 104 includes an adhesive and a fire-retardant additive 105. Some examples of adhesives that may be used in adhesive layer are: acrylic adhesive, natural rubber, synthetic rubber, silicone, polyester, polyolefin, rosin, and epoxy adhesive resins, not limited to these general pressure sensitive adhesive resins and combinations thereof. Adhesive layer 104 may be the same adhesive as adhesive layer 102, or may be a different adhesive. Factors that contribute to a choice adhesive type include a desire to for an adhesive to adhere well to a film layer, or the adhesive layers to adhere well to each other. Some examples of suitable fire-retardants include: tris(tribromoneopentyl) phosphate (TTBP), antimony trioxide (ATO) flame retardant, ammonium polyphosphate (APP) flame retardant, alumina trihydrate (ATH) flame retardant, and antimony trioxide (SbO₂) flame retardant. Fire retardant additive 105 may be added in an amount of, for example 30%, 35%, 40%, 45%, 50%, 55%, 60%, 65%, 70%, 75% or 80% by weight. The total thickness of adhesive layer 104 may be about 8 um, 10 um, 12 um, 15 um, 20 um, 25 um, 30 um, 35 um, 40 um, 45 um, 50 um, 55 um, 60 um, 65 um, 70 um, 75 um or any range between any of these thicknesses. The total thickness of adhesive layer 106 may be about 3 um, 5 um, 6 um, 8 um, 10 um, 12 um, 15 um, 20 um, 25 um, 30 um, 35 um, 40 um, 45 um, 50 um, 55 um, 60 um, 65 um, 70 um, 75 um or any range between any of these thicknesses. The combined thickness of adhesive layer 104 and 106 may be in the range of 12 um, 15 um, 20 um, 25 um, 30 um, 35 um, 40 um, 45 um, 50 um, 55 um, 60 um, 65 um, 70 um, 75 um, 80 um, 85 um, 90 um, 95 um, 100 um, 110 um, 120 um, 130 um, 140 um or 150 um or any range between any of these thicknesses.

Adhesive layer 106 does not include any substantial amount of fire retardant. Adhesive layer 106 may include acrylic adhesive, natural rubber, synthetic rubber, silicone, polyester, polyolefin, rosin, and epoxy adhesive resins, not limited to these general pressure sensitive adhesive resins and combinations thereof. Fire retardant additives can have the effect of decreasing adhesion. However, they can be highly important to meeting flammability requirements. By including a layer of adhesive with fire retardant additives, adhesive layer 104, and a layer of adhesive without fire retardant additives, layer 106, the present disclosure can meet flammability standards and retain the required adhesion performance, including both peel and tack.

As shown in FIG. 1, film construction 100 is applied to substrate 108. Substrate 108 is shown as a horizontal substrate in FIG. 1; however, substrate 108 may be horizontal, vertical, at any angle, or curved. Substrate 108 may be, for example, an interior or exterior wall or structure of a building. Substrate 108 may be a vehicle, such as a tractor-trailer or a train or aircraft. In some instances a primer may be used to increase adhesion between the film construction 100 and substrate 108.

FIG. 2 shows a film construction 200 with three layers of adhesive. In FIG. 2, film layer 202 may be made of the same materials as film layer 102 in FIG. 1. Adhesive layer 203 is adjacent to film layer 202 and also adjacent to adhesive layer 204. Adhesive layer 206 is adjacent to the opposite side of adhesive layer 204, and contacts a substrate 208 to which film construction 200 may be applied. In this instance, adhesive layer 204 may be made of the same materials as adhesive layer 104 of FIG. 1. Adhesive layers 203 and 206 may be made of the same materials as adhesive layer 106. Fire retardant additive 205 may be of the same materials as fire retardant additive 105. The thickness of adhesive layer 204 may range from 8 um, 10 um, 12 um, 15 um, 20 um, 25 um, 30 um, 35 um, 40 um, 45 um, 50 um, 55 um, 60 um, 65 um, 70 um, 75 um or any range between any of these thicknesses. Adhesive layer 203 may range in thickness between 3 um, 5 um, 6 um, 8 um, 10 um, 12 um, 15 um, 20 um, 25 um, 30 um, 35 um, 40 um, 45 um, 50 um, 55 um, 60 um, 65 um, 70 um, and 75 um or any range between any of these thicknesses. Adhesive layer 206 may range in thickness 3 um, 5 um, 6 um, 8 um, 10 um, 12 um, 15 um, 20 um, 25 um, 30 um, 35 um, 40 um, 45 um, 50 um, 55 um, 60 um, 65 um, 70 um, and 75 um or any range between any of these thicknesses. The total thickness of all three of adhesive layers may range from 14 um, 17 um, 20 um, 25 um, 30 um, 35 um, 40 um, 45 um, 50 um, 55 um, 60 um, 65 um, 70 um, 75 um, 80 um, 85 um, 90 um, 95 um, 100 um, 110 um, 120 um, 130 um, 140 um or 150 um, 175 um, 200 um, 225 um or any range between any of these thicknesses.

FIG. 3 shows a film construction 300 with a liner 307. The film construction with film layer 302, adhesive layer 304 and adhesive layer 306 is very similar to the film construction in FIG. 1, except that FIG. 3 shows a liner adjacent to adhesive liner 307. The film construction 300 is typically sold attached to a liner to allow a customer to remove the liner before applying the film construction 300 to a substrate. Line 307 may have a release coating. In some instances, liner 307 may have structures so as to create posts in adhesive layer 306 to allow increased slidability of the film construction for easy placement during application of the film construction 300 to a substrate. Liner 307 may also have ridges which form channels in adhesive layer 306 to allow for easy release of air bubbles that may otherwise become trapped during installation.

### EXAMPLES

Film article examples were prepared with layered pressure sensitive adhesives that provide good low combustibility while also maintaining good adhesion to a substrate.

These examples are merely for illustrative purposes only and are not meant to be limiting on the scope of the appended claims. All parts, percentages, ratios, etc. in the examples and the rest of the specification are by weight, unless noted otherwise. The following abbreviations are used herein: mm=millimeters; um=micrometers; mm/min=millimeters per minute; N/in=Newton per inch; g=gram; kg=kilogram; kgf=kilogram force; phr=parts per hundred; MJ/m²=megajoules per meters squared; kW/m²=kilowatt per meter squared.

### Abbreviations for Materials

| | |
|---|---|
| FILM 1 | Calendared polyvinyl chloride film with 19.5% plasticizer, |
| | 12.7% organic stabilizer, 1.3% organic pigment, 135 um thick, |
| | from Tatsuta Chemical Co., Ltd., Japan. The film surface was |
| | corona treated prior to use. |
| FILM 2 | Calendared polyvinyl chloride film with 19.5% plasticizer, |
| | 12.7% organic stabilizer, 1.3% organic pigment, 174 um thick, |
| | from Bando Chemical Industries, Ltd., Japan |
| FILM 3 | Low Density Polyethylene (LDPE) film, 80 microns thick, film |
| | was extruded using a single screw extruder with resin |
| | available from Equistar Chemicals, LP, Houston, TX, as |
| | PETROTHENE NA217000 |
| FILM 4 | Ethylene and methyl acrylate copolymer (EMA) film, 75 |
| | microns thick, film was extruded using a single screw extruder |
| | with resin available from DuPont Company, Wilmington, DE, |
| | as ELVALOY1609 |
| FILM 5 | Polypropylene (PP) film, 33 microns thick, film was extruded |
| | using a single screw extruder with resin available from Exxon |
| | Mobil, as PP1013H1 |
| FILM 6 | Polyethylene terephthalate (PET) film, 25 microns thick, film |
| | was available from DuPont Teijin Films U.S. Ltd, Chester, VA, |
| | as MELINEX S |
| FILM 7 | Polyimide (PI) film, 25 microns thick, film was extruded using |
| | a single screw extruder with resin available from DuPont |
| | Company, Wilmington, DE, as KAPTON E |
| FILM 8 | Polyurethane (PU) film, 20 microns thick. Urethane resin |
| | solution was a formulation of 14.3 weight percent crosslinker |
| | added to 85.7 weight percent polyurethane resin. The |
| | polyurethane resin was coated by hand onto LINER using a |
| | notch bar coater, then dried at 65 degrees C. for 2 minutes, |
| | followed by 120 degrees C. for 2 minutes: |
| | Polyurethane base resin available from Tosoh |
| | Corporation, Japan, as MCPV-12 |
| | Crosslinker available from Tosoh Corporation, |
| | Japan, as CORONATE HX |
| FILM 9 | Polyvinylidene fluoride (PVDF) film, 20 microns thick, |
| | available from Denka Company Ltd., Japan, as DX-14S0220 |
| LINER | Polyester release liner, silicone coated polyester release liner |
| | for pressure sensitive adhesives available from Toray |
| | Advanced Film Co., Ltd., Japan, as CERAPEEL WZ |
| RESIN | Acrylic pressure sensitive adhesive resin, available from |
| | Nippon Synthetic Chemical Industry Co., Ltd., Japan, as AR- |
| | 2422 |
| CL | Crosslinker, Polyisocyanate available from Tosoh Corp., Japan, |
| | as L-55E |
| FR1 | Tris(tribromoneopentyl) phosphate (TTBP) flame retardant, |
| | available from ICL Industrial Products, Japan, as FR-370 |
| FR2 | Antimony trioxide (ATO) flame retardant, available from |
| | Chemtura, Middlebury, CT., as TMS |
| FR3 | Ammonium polyphosphate (APP) flame retardant, available |
| | from Clariant International Ltd., Muttenz, Switzerland, as |
| | EXOLIT AP423 |
| FR4 | Alumina trihydrate (ATH) flame retardant, available from |
| | Huber Engineered Materials, Atlanta, GA., as MICRAL 1500 |
| FRS | Antimony trioxide (SbO₂) flame retardant, available from |
| | Yamanaka & Co., Ltd., Japan, as MSA |
| PRIMER | Water based primer for walls, available from 3M Japan |
| | Company, Sumitomo, Japan, as WP-246 |

### Test Methods

### Flammability Test

Equipment: Cone calorimeter per ISO5660-1.

Substrate: Incombustible plasterboard, 12.5 mm thickness from American Gypsum, Dallas, Tex.

Sample preparation: The plasterboard was coated with a primer for adhesion promotion using PRIMER at 10 g solids per square meter and allowed to dry at room temperature. The polyester release liner was peeled from the adhesive side of the film article, and the film article was adhered to the primed plasterboard using a flat plastic squeegee to remove air bubbles.

Flammability acceptance criteria: THR=Total heat release less than or equal to 8 MJ/m² as measured over a period of 20 minutes. FIGRA=Fire Growth Rate is less than or equal to 8 KW/(m²*s). FIGRA is the peak heat release rate (KW/(m²)) divided by the time to the peak(s).

### 180 Peel Adhesion Test

Equipment: Tensilon RTG series tensile tester from A&D Co., Ltd., Japan.

Substrate: Bonderized steel plate from MSC Industrial Supply, Melville, N.Y.

Temperature: 20 degrees C., room temperature.

Aging time: Peel was done 48 hours after lamination of film to substrate.

Sample Preparation: A 25 mm×150 mm film article sample was laminated to a substrate with 1 kg weighted roller. The substrate was cleaned by wiping with Isopropyl alcohol before laminating.

Testing: After aging, the sample was peeled at a 180 degree angle from the substrate at a speed of 300 mm/min. Three samples were tested and averaged for each condition. Results are reported in N/in.

Peel adhesion acceptance criteria: greater than or equal to 20 N/in.

### Loop Tack Adhesive Test

Equipment: Tensilon RTG series tensile tester from A&D Co., Ltd., Japan.

Substrate: Vinyl film, FILM 2.

Temperature: 5 degrees C.

Sample Preparation: A 25 mm wide×150 mm long film article sample was curved into a loop (where the ends did not overlap) with the adhesive on the outside of the loop.

Testing: The sample was contacted to the substrate at a speed of 1000 mm/min until 30 mm length of film was adhered to the substrate. Then the sample was immediately peeled from the substrate at a speed of 100 mm/min. Three samples were tested and averaged for each condition. Results are reported in N/in.

Loop tack acceptance criteria: greater than or equal to 15 N/in.

### Probe Tack Adhesive Test

Equipment: TE-6002 Probe Tack Tester with Chamber from Tester Sangyo Co., Ltd., Japan

Chamber Temperature: 5 degrees C.

Sample Preparation: The exposed adhesive side of the film article was tested.

Testing: Cold temperature tackiness was measured following equipment operating manual instructions. Three samples were tested for each example and the results were averaged. Results are reported in kgf.

Probe tack acceptance criteria: greater than or equal to 2.5 kgf.

### Example 1: 2-Layer Adhesive

Calendared PVC films were laminated with two layered adhesives, the combined adhesive layers totaling 38 um. The inner adhesive layers, the adhesive layer between the film and the outer adhesive layer, were formulated with different percentages of flame retardant fillers as described in Table 1. The outer adhesive layers contained no flame retardant fillers. Comparative Examples were made, one without flame retardant filler (CE1-1) and one with flame retardant filler throughout the entire adhesive (CE1-2).

Each adhesive layer was formulated from CL added at 2.17 phr to acrylic adhesive RESIN. Each adhesive layer was coated by hand onto LINER using a notch bar coater, then dried at 65 degrees C. for 2 minutes, followed by 95 degrees C. for 2 minutes.

Each adhesive layer was subsequently laminated between rubber nip rollers to FILM 1 for adhesion testing or FILM 2 for flammability testing, and each LINER was removed. Samples for Flammability Testing, 180 Degree Peel Adhesion Testing, and Loop Tack Testing were prepared as indicated in the Test Methods. Results are shown in Table 1.

TABLE 1
2-Layer Adhesive Examples

| Example 1 | | | E1-1 | E1-2 | CE1-1 | CE1-2 |
|---|---|---|---|---|---|---|
| Inner | Weight g | RESIN | 16.7 | 45.8 | 97.9 | 65.2 |
| adhesive | | CL | 0.5 | 1.4 | 2.1 | 2.0 |
| layer | | FR1 | 25.0 | 25.0 | 0 | 25.0 |
| | | FR2 | 7.8 | 7.8 | 0 | 7.8 |
| | | Total g | 50.0 | 80.0 | 100.0 | 100.0 |
| | Filling % | | 65.5% | 41.0% | 0 | 32.8% |
| | Thickness | | 19 | 30 | 38 | 38 |
| | um | | | | | |
| Outer | Weight g | RESIN | 48.4 | 19.4 | — | — |
| adhesive | | CL | 1.5 | 0.6 | — | — |
| layer | | Total g | 50.0 | 20.0 | — | — |
| | Filling % | | 0 | 0 | | |
| | Thickness | | 19 | 8 | — | — |
| | um | | | | | |

| | | | | |
|---|---|---|---|---|
| Filled adhesive thickness percent | 50% | 79% | 0 | 100% |
| Total adhesive thickness um | 38 | 38 | 38 | 38 |
| Loop tack N/in | 17.5 | 17.1 | 18.2 | 10.6 fail |
| 180 Peel adhesion N/in | 29.7 | 30.0 | 30.0 | 28.8 |
| Flammability THR MJ/m² | <8 | <8 | >8 fail | <8 |

Example E1-1 has 65.5% filled inner layer adhesive of 19 um with flame retardants and unfilled outer layer adhesive 19 um. E1-1 passed the Total Heat Release criterion, the 180 Peel Adhesion Test, and the Loop Tack Adhesive Test.

Example E1-2 has 41.0% filled inner layer adhesive of 30 um with flame retardants and unfilled outer layer adhesive of 8 um. E1-2 passed the Total Heat Release criterion, the 180 Peel Adhesion Test, and the Loop Tack Adhesive Test.

Example CE1-1 has a standard single layer of unfilled adhesive of 38 um. CE1-1 failed the Total Heat Release criterion. However, CE1-1 passed the 180 Peel Adhesion Test, and the Loop Tack Adhesive Test.

Example CE1-2 has a single layer 32.8% filled adhesive of 38 um with flame retardants. CE1-2 passed the Total Heat Release criterion and the 180 Peel Adhesion Test. However, CE1-2 failed the Loop Tack Adhesive Test.

### Example 2: Various Flame Retardant Fillers

Calendared PVC film article samples with adhesive layers were prepared as described in Example 1 with the following changes. A variety of flame retardants were used, as well as thinner adhesive layers as described in Table 2. Flammability testing, 180 degree peel adhesion, and probe tack samples were prepared as indicated in the Test Methods. Results are shown in Table 2.

TABLE 2
Various Flame Retardant Filler Examples

| Example 2 | | | E2-1 | E2-2 | E2-3 | E2-4 | E2-5 | E2-6 |
|---|---|---|---|---|---|---|---|---|
| Inner | Filling % | FR3 | 50% | 0 | 0 | 0 | 0 | 50% |
| adhesive | | FR4 | 0 | 50% | 0 | 0 | 0 | 0 |
| layer | | FR1/FR5 | 0 | 0 | 50% | 50% | 50% | 0 |
| | | at 50/50 | | | | | | |
| | Thickness | | 30 | 30 | 30 | 19 | 12 | 19 |
| | um | | | | | | | |
| Outer | Filling % | | 0 | 0 | 0 | 0 | 0 | 0 |
| adhesive | Thickness | | 8 | 8 | 8 | 19 | 26 | 19 |
| layer | um | | | | | | | |

| | | | | | | |
|---|---|---|---|---|---|---|
| Filled adhesive thickness percent | 79% | 79% | 79% | 50% | 32% | 50% |
| Total adhesive thickness um | 38 | 38 | 38 | 38 | 38 | 38 |
| Probe tack kgf | 2.5 | 2.6 | 3.0 | 3.1 | 3.5 | 4.1 |
| 180 Peel adhesion N/in | 37 | 29 | 33 | 35 | 39 | 36 |
| Flammability THR MJ/m² | 7 | 8 | 8 | 7 | 8 | 8 |
| FIGRA seconds | 4.6 | 6.9 | 5.2 | 4.3 | 5.8 | 7.6 |

Examples E2-1 through E2-6 have a 50% filled inner layer adhesive of 12-30 um with a variety of different flame retardants and an unfilled outer layer adhesive of 8-26 um. Each of E2-1 through E2-6 passed both the THR and FIGRA criterion in the Flammability Test, the 180 Peel Adhesive Test and the Loop Tack Adhesive Test.

### Example 3: 3-Layer Adhesive

Calendared PVC film article samples with adhesive layers were prepared as described in Example 1. As shown in Table 3, Example 3 had three layers of adhesive with a highly 65% filled middle layer adhesive of 25 microns, an additional unfilled inner layer adhesive of 6.5 um, and unfilled outer layer adhesive of 6.5 um. The unfilled and filled adhesive layers have thickness to add up to a total thickness for the three layer adhesive of 38 um. Flammability testing, 180 degree peel adhesion, and probe tack samples were prepared as indicated in the Test Methods. Results are shown in Table 3.

TABLE 3
3-Layer Adhesive Example

| Examples 3 | | | E3 |
|---|---|---|---|
| Inner | Filling % | | 0 |
| adhesive | Thickness | | 6.5 |
| layer | um | | |
| Middle | Filling % | FR1/FR5 | 65% |
| adhesive | | at 50/50 | |
| layer | Thickness | | 25 |
| | um | | |
| Outer | Filling % | | 0 |
| adhesive | Thickness | | 6.5 |
| layer | um | | |

| | |
|---|---|
| Filled adhesive thickness percent of | 66% |
| total adhesive thickness | |
| Total adhesive thickness um | 38 |
| Probe tack kgf | 2.5 |
| 180 Peel adhesion N/in | 29 |
| Flammability THR MJ/m² | 7 |
| FIGRA KW/(m²*s) | 4.9 |

Example E3 with three layers of adhesive passed the THR and FIGRA criteria of the Flammability Test, the 180 Peel Adhesive Test and the Loop Tack Adhesive Test.

### Example 4: Various Adhesive Layer Thickness

Calendared PVC film article samples with adhesive layers were prepared as described in Example 1 with the following changes. A range of adhesive layer thickness were used, described in Table 4. Comparative Examples (CE4-1, 2) were made, as indicated in Table 4. Flammability testing and 180 degree peel adhesion samples were prepared as indicated in the Test Methods. Results are shown in Table 4.

TABLE 4
Various Adhesive Layer Thickness Examples

| Example 4 | | | E4-1 | E4-2 | E4-3 | CE4-1 | CE4-2 |
|---|---|---|---|---|---|---|---|
| Inner | Filling % | | — | 0 | — | — | — |
| adhesive | Thickness | | — | 6.5 | — | — | — |
| layer | um | | | | | | |
| Middle | Filling % | FR 3 | 50% | 50% | 50% | 50% | 50% |
| adhesive | Thickness | | 12 | 30 | 30 | 6.5 | 8 |
| layer | um | | | | | | |
| Outer | Filling % | | 0 | 0 | 0 | 0 | 0 |
| adhesive | Thickness | | 6.5 | 8 | 6.5 | 38 | 2 |
| layer | um | | | | | | |

| | | | | | |
|---|---|---|---|---|---|
| Filled adhesive thickness percent | 65% | 67% | 82% | 15% | 80% |
| Total adhesive thickness um | 18.5 | 44.5 | 36.5 | 44.5 | 10 |
| 180 Peel adhesion N/in | >20 | 29-39 | 29-39 | >20 | <20 fail |
| Flammability THR MJ/m² | <8 | <8 | <8 | >8 fail | <8 |

Examples E4-1, E4-2, and E4-3 have 50% a filled inner layer adhesive from 12 to 30 um with flame retardant and unfilled outer layer adhesive from 6.5 to 8 um, giving a total adhesive thickness range from 18.5 to 44.5 um. Each of E4-1, E4-2 and E403 passed the THR Criterion of the Flammability Test and the 180 Peel Adhesive Test.

Example CE4-1 has 50% filled inner layer adhesive of 6.5 um with flame retardant and unfilled outer layer adhesive of 38 um. CE4-1 failed the THR Criterion of the Flammability Test, but passed the 180 Peel Adhesive Test.

Example CE4-2 has 50% filled inner layer adhesive of 8 um with flame retardant and unfilled outer layer adhesive of 2 um. CE4-2 failed the 180 Peel Adhesion Test but passed the THR Criterion of the Flammability Test.

### Example 5: Various Film Material Layers

Film article samples with adhesive layers were prepared as described in Example 1 with the following changes. A variety of film materials were used, described in Table 5. Flammability testing samples were prepared as indicated in the Test Methods. Results are shown in Table 5.

TABLE 5
Various Film Materials Layers Examples

| Example 5 | | | E5-1 | E5-2 | E5-3 | E5-4 | E5-5 | E5-6 | E5-7 |
|---|---|---|---|---|---|---|---|---|---|
| Film layer | Film | | FILM 3 | FILM 4 | FILM 5 | FILM 6 | FILM 7 | FILM 8 | FILM 9 |
| | Thickness | | 80 | 75 | 33 | 25 | 25 | 20 | 20 |
| | um | | | | | | | | |
| Inner | Filling % | | 0 | 0 | 0 | 0 | 0 | — | — |
| adhesive | Thickness | | 3 | 3 | 3 | 3 | 3 | — | — |
| layer | um | | | | | | | | |
| Middle | Filling % | FR3 | 50% | 50% | 50% | 50% | 50% | 50% | 50% |
| adhesive | Thickness | | 34 | 34 | 34 | 34 | 34 | 30 | 30 |
| layer | um | | | | | | | | |
| Outer | Filling % | | 0 | 0 | 0 | 0 | 0 | 0 | 0 |
| adhesive | Thickness | | 3 | 3 | 3 | 3 | 3 | 8 | 8 |
| layer | um | | | | | | | | |

| | | | | | | | |
|---|---|---|---|---|---|---|---|
| Filled adhesive thickness percent | 85% | 85% | 85% | 85% | 85% | 79% | 79% |
| Total adhesive thickness um | 40 | 40 | 40 | 40 | 40 | 38 | 38 |
| Flammability THR MJ/m² | 7.8 | 7.4 | 6.6 | 5.7 | 0.9 | 5.8 | 6.7 |
| FIGRA KW/(m²*s) | 5.3 | 7.2 | 6.7 | 5.0 | 0.03 | 0 | 0 |

Examples E5-1 through E5-7 have seven different typical film materials and 50% filled inner layer adhesive of 30-34 um with flame retardants and unfilled outer layer adhesive of 3-8 um. Each of E5-1 through E5-7 passed the FIGRA and THR Criterion of the Flammability Test.

1. A low-combustibility film construction comprising:
a film layer;
a first adhesive layer with a fire-retardant additive of at least 41% by weight;
a second adhesive layer;
wherein the total thickness of the first and the second adhesive layers is in the range of 18.5 to 44.5 microns; and
wherein the total thickness of the fire retardant adhesive layer is 32% to 85% of the total thickness of the first and second adhesive layers.

2. The film construction of claim 1, wherein the film layer comprises at least one of: polyvinylchloride (PVC), polyester, polyethylene terephthalate, low density polyethylene, ethylene methacrylate copolymer, polypropylene, polyimide, polyurethane, polyinylidene fluoride, polymethyl methacrylate, acrylic, silicone, and polyolefin films.

3. The film construction of claim 1, wherein the film is a graphic film and an ink layer is deposited on the film layer.

4. The film construction of claim 1, wherein the film layer has a thickness of 200 microns or less.

5. The film construction of claim 1, wherein the film layer has a thickness in the range of 125-145 microns.

6. The film construction of claim 1, wherein the first adhesive layer is adjacent to the film layer.

7. The film construction of claim 1, further comprising a third adhesive layer, wherein the third adhesive layer does not have a fire retardant additive, and wherein the third adhesive layer is disposed between the film layer and the first adhesive layer.

8. The film construction of claim 1, wherein the first adhesive layer comprises at least one of: acrylic adhesive, natural rubber, synthetic rubber, silicone, polyester, polyolefin, rosin, and epoxy adhesive resins, not limited to these general pressure sensitive adhesive resins.

9. The film construction of claim 1, wherein the second adhesive layer comprises acrylic adhesive.

10. The film construction of claim 1, wherein the film construction has a peel adhesion greater than or equal to 20 N under the 180 Peel Adhesion Test.

11. The film construction of claim 1, wherein the film construction has a total heat release less than or equal to 8 MJ/m² under the flammability test.

12. The film construction of claim 1, wherein the film construction has a Fire Growth Rate (FIGRA) of less than or equal to 8 KW/(m²*s).

13. The film construction of claim 1, wherein the fire retardant additive comprises at least one of: tris(tribromoneopentyl) phosphate (TTBP), antimony trioxide (ATO) flame retardant, ammonium polyphosphate (APP) flame retardant, alumina trihydrate (ATH) flame retardant, and antimony trioxide (SbO₂) flame retardant.

14. A low-combustibility film construction comprising:
a film layer;
a first adhesive layer with a fire-retardant additive of at least 41% by weight;
a second adhesive layer;
wherein the total thickness of the first adhesive layer is 32% to 85% of the total thickness of the first and second adhesive layers, and wherein the film has a peel adhesion greater than or equal to 20 N under the 180 Peel Adhesion Test.

15. The film construction of claim 14, further comprising a third adhesive layer, wherein the third adhesive layer does not have a fire retardant additive, and wherein the third adhesive layer is disposed between the film layer and the first adhesive layer.

16. The film construction of claim 14, wherein the first adhesive layer comprises at least one of: acrylic adhesive, natural rubber, synthetic rubber, silicone, polyester, polyolefin, rosin, and epoxy adhesive resins, not limited to these general pressure sensitive adhesive resins.

17. The film construction of claim 1, wherein the fire retardant additive comprises at least one of: tris(tribromoneopentyl) phosphate (TTBP), antimony trioxide (ATO) flame retardant, ammonium polyphosphate (APP) flame retardant, alumina trihydrate (ATH) flame retardant, and antimony trioxide (SbO₂) flame retardant.

18. A low-combustibility film construction comprising:
a film layer;
a first adhesive layer with a fire-retardant additive of at least 41% by weight;
a second adhesive layer;
wherein the total thickness of the first and the second adhesive layers is in the range of 18.5 to 44.5 microns; and wherein the film has a total heat release less than or equal to 8 MJ/m² under the Flammability Test and wherein the film construction has a Fire Growth Rate (FIGRA) of less or equal to 8 KW/(m²*s).

19. The film construction of claim 18, further comprising a third adhesive layer, wherein the third adhesive layer does not have a fire retardant additive, and wherein the third adhesive layer is disposed between the film layer and the first adhesive layer.

20. (canceled)

21. The film construction of claim 1, wherein the fire retardant additive comprises at least one of: tris(tribromoneopentyl) phosphate (TTBP), antimony trioxide (ATO) flame retardant, ammonium polyphosphate (APP) flame retardant, alumina trihydrate (ATH) flame retardant, and antimony trioxide (SbO₂) flame retardant.
